(19) United States
(12) Patent Application Publication
(10) Pub. No.: US 2017/0114752 A1
(43) Pub. Date: Apr. 27, 2017

(54) STANDING WAVE COMPRESSOR PULSEJET ENGINE

(71) Applicant: Honda Patents & Technologies North America, LLC, Torrance, CA (US)

(72) Inventor: Brett M. Schoppa, Summerfield, NC (US)

(21) Appl. No.: 15/334,783

(22) Filed: Oct. 26, 2016

Related U.S. Application Data
(60) Provisional application No. 62/246,814, filed on Oct. 27, 2015.

(51) Int. Cl. F02K 7/04

(52) U.S. Cl. CPC F02K 7/04

(57) ABSTRACT

A compressor assembly for a pulsejet engine. The pulsejet engine including a burner positioned within a combustion chamber of the pulsejet engine. The compressor assembly includes a compressor coupled in fluid communication with the combustion chamber. The compressor is adapted to intake a first volume of air and to release a volume of compressed air. The burner is configured to receive the volume of compressed air and release a volume of a burned compressed air and fuel mixture. An active valve is operatively coupled between the compressor and the combustion chamber. The active valve is adapted to control entry of the volume of compressed air into a first end of the burner. A standing wave is formed inside the compressor to compress the first volume of air during operation of the pulsejet engine.

This application claims the benefit of U.S. provisional patent application Ser. No. 62/246,814, filed Oct. 27, 2015, which is incorporated by reference in its entirety herein.

### BACKGROUND

The subject matter disclosed herein relates to pulsejet engines, and more specifically, to compression and combustion systems for pulsejet engines.

Conventional pulsejet engines include a combustion chamber and a tailpipe to produce thrust that may be utilized, for instance, for propelling a craft. In operation, air flows through an intake of the pulsejet engine and mixes with a fuel to form a combustible air-fuel mixture. The air-fuel mixture is ignited with a spark inside the combustion chamber to produce an explosive gas. The explosive gas, which contains highly energetic combustion products, expands through the combustion chamber and down the tailpipe toward an exit. This process repeats with input of fuel and intake of air into the combustion chamber to yield a pulsating stream of exhaust gas that exits the tailpipe and provides the thrust.

Typically, pulsejet engines do not compress the air flow that enters the combustion chamber. As a result, pulsejet engines offer low compression ratios, for instance, in the range of 1.2:1. On the other hand, turbofan engines can offer compression ratios of 15:1 or more. In operation, low compression ratios lend to poor fuel efficiency and fuel economy, because less explosive power is generated during the combustion cycle. Therefore, there exists a need for an improved pulsejet engine. This disclosure is intended to address the above-noted needs and to provide related advantages.

### SUMMARY

In one aspect, a pulsejet engine includes a compressor adapted to intake a volume of air and to release a volume of compressed air. A combustion chamber is in fluid communication with the compressor. A burner is positioned in the combustion chamber and includes a first end configured to receive the volume of compressed air and a second end configured to release a volume of a burned compressed air and fuel mixture. An active valve is operatively coupled between the compressor and the combustion chamber. The active valve is adapted to control entry of the volume of compressed air into a first end of the burner. A standing wave is formed inside the compressor to compress the first volume of air during operation of the pulsejet engine.

In another aspect, a method of operation for a pulsejet engine includes receiving a volume of air within a compressor and compressing the volume of air toward an aft end of the compressor. Compression of the volume of air is provided for by standing waves formed inside the compressor. An active valve operatively coupled to the aft end of the compressor is opened to permit a volume of compressed air to exit the compressor and enter a burner positioned within a combustion chamber in fluid communication with the compressor. The active valve is closed prior to burning at least a portion of the volume of compressed air in the burner.

In yet another aspect, a compressor assembly for a pulsejet engine is provided. The pulsejet engine includes a burner positioned within a combustion chamber of the pulsejet engine. The compressor assembly includes a compressor coupled in fluid communication with the combustion chamber. The compressor is adapted to intake a volume of air and to release a volume of compressed air. The combustion chamber and the burner are configured to receive the volume of compressed air and release a volume of a burned compressed air and fuel mixture. An active valve is operatively coupled between the compressor and the combustion chamber and adapted to control entry of the volume of compressed air into a first end of the combustion chamber. A standing wave is formed inside the compressor to compress the volume of air during operation of the pulsejet engine.

### BRIEF DESCRIPTION OF THE DRAWINGS

FIG. 1 is a schematic diagram of an exemplary standing wave compressor pulsejet engine according to one embodiment;

FIG. 2 is a schematic diagram of an alternative embodiment of a standing wave compressor pulsejet engine having a reservoir in fluid communication with an active valve system;

FIGS. 3 and 4 are schematic diagrams of a first mode of operation for the standing wave compressor pulsejet engine of FIGS. 1 and 2;

FIGS. 5 and 6 are schematic diagrams of a second mode of operation for the standing wave compressor pulsejet engine of FIGS. 1 and 2;

FIG. 7 is a schematic diagram of an alternative embodiment of a standing wave compressor pulsejet engine having a diaphragm or piston at an end of the compressor driven by pressure pulses from a combustion chamber;

FIGS. 8 and 9 are schematic diagrams of an alternative embodiment of a standing wave compressor pulsejet engine;

FIG. 10 is a diagram illustrating a bent connection between a compressor and a burner for the standing wave compressor pulsejet engine of FIGS. 1 and 2;

FIG. 11 is a diagram illustrating multiple compressors connected in series and further connected to the burner of the standing wave compressor pulsejet engine of FIGS. 1 and 2;

FIG. 12 is a diagram illustrating multiple compressors connected in parallel and further connected to the burner of the standing wave compressor pulsejet engine of FIGS. 1 and 2;

FIG. 13 is a perspective view of an exemplary combustion chamber having multiple rods in the standing wave compressor pulsejet engine of FIGS. 1 and 2;

FIG. 14 is a close-up view of a multi-rod arrangement of FIG. 10 according to one embodiment; and

FIG. 15 illustrates an exemplary method of operation for a pulsejet engine according to one embodiment.

Other aspects and advantages of certain embodiments will become apparent upon consideration of the following detailed description, wherein similar structures have similar reference numerals.

### DETAILED DESCRIPTION

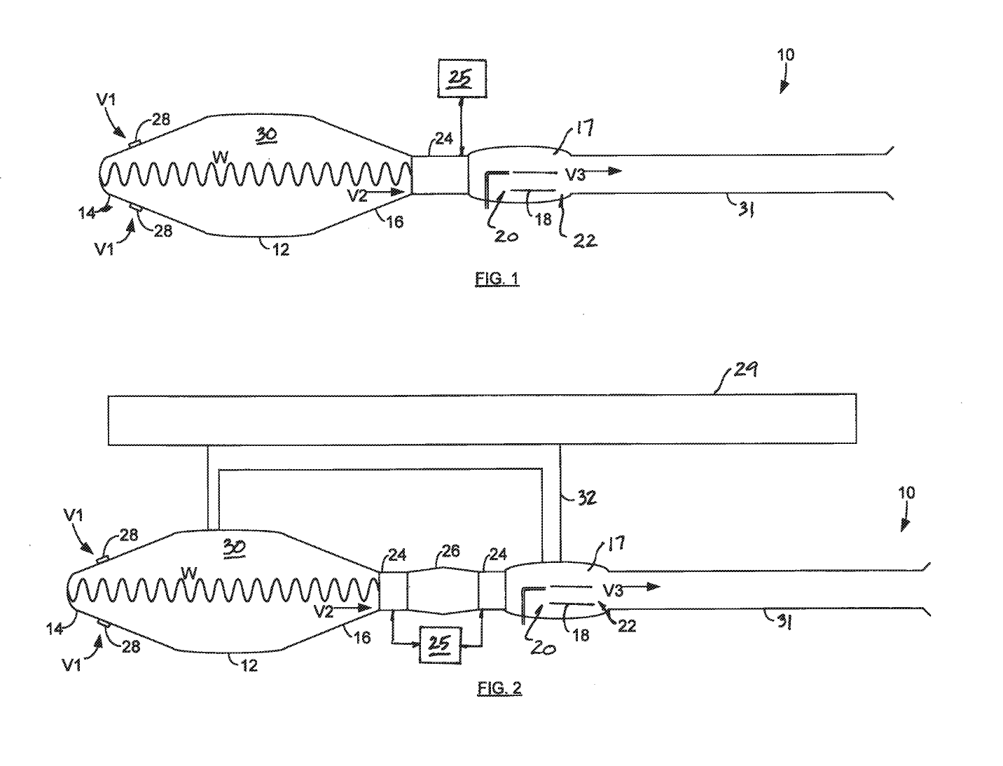

FIGS. 1 and 2 show schematic diagrams of a standing wave compressor pulsejet engine 10 (herein referred to as “pulsejet engine”) according to certain embodiments of the present disclosure. The pulsejet engine 10 includes a compressor 12 adapted to intake a first volume of air V1 and to release a volume of compressed air V2. In one embodiment, the compressor 12 has a forward end 14 adapted to intake the first volume of air V1 and an aft end 16 adapted to release the volume of compressed air V2. In alternative embodiments, the first volume of air V1 may enter at or near the forward end 14, at or near the aft end 16 and/or at one or more locations between and including the forward end 14 and the aft end 16. The one or more locations through which air enters the compressor 12 depends, at least in part, on the design and configuration of the compressor 12.

The pulsejet engine 10 further includes a combustion chamber 17 in fluid communication with the aft end 16 of the compressor 12. In one embodiment, one or more burners 18 are housed or positioned within the combustion chamber 17 and also in fluid communication with the aft end 16 of the compressor 12. Typical burners burn only a portion of the compressed air, with the burned gases mixing with the unburned portion of the compressed air after combustion has taken place. As described herein, while in certain embodiments the burner 18 is not necessarily essential to the working of the pulsejet engine 10, with the burner 18 positioned within the combustion chamber 17 the efficiency of the pulsejet engine 10 may be improved by facilitating combustion of the compressed air within the combustion chamber 17. The burner 18 includes a first end 20 configured to receive the volume of compressed air V2 and a second end 22 configured to release a volume of a burned compressed air and fuel mixture V3. As shown in FIG. 1, in some embodiments, the pulsejet engine 10 includes an active valve 24 operatively coupled between the compressor 12 and the combustion chamber 17 and/or the burner 18. As shown in FIG. 2, in an alternative embodiment, the pulsejet engine 10 includes a reservoir 26 disposed between a pair of active valves 24. In both FIGS. 1 and 2, the active valve 24 is adapted to control entry of the volume of compressed air V2 into the first end 20 of the burner 18. It is contemplated that during operation of the pulsejet engine 10, a standing wave W is formed inside the compressor 12 and provides for compression of the first volume of air V1. In operation, the compressor 12, in combination with the active valve 24, provides for a simple and cost-effective system that enhances a compression ratio and a thrust-to-weight ratio of the pulsejet engine 10. It is contemplated that the arrangements described herein lend to greater fuel efficiency of the pulsejet engine 10, with little to no additional mechanical complexity or cost to the pulsejet engine 10.

Still referring to FIGS. 1 and 2, the active valve 24 can be opened and closed to control an operational frequency of the pulsejet engine 10. In particular, the active valve 24 may be opened when a pressure level of the combustion chamber 17 and the burner 18 are below a pressure level of the compressor 12 to allow the volume of compressed air V2 to leave the compressor 12 and enter the combustion chamber 17 and the burner 18 where a combustion process begins. Further, in one embodiment the active valve 24 is closed prior to initiation of the combustion process. In one aspect, a control system 25 is in operational control communication with the active valve 24 and controls the opening and/or closing of the active valve 24. The control system 25 may be configured to receive user input and/or have preprogrammed commands that provide for automatic and/or manual control of the active valve 24. The control system 25 may permit user control and adjustment of operational variables, including, without limitation, a timing sequence for opening and closing the active valve 24, monitoring and receiving user input on various temperature and pressure level settings of components of the pulsejet engine 10, and setting a level of opening of the active valve 24. In this way, it is contemplated that the active valve 24 allows for active or selectable tuning of various modes of operation of the pulsejet engine 10 to achieve improved power and efficiency of the pulsejet engine 10.

As shown in FIG. 2, in an alternative embodiment of the pulsejet engine 10, the reservoir 26 is positioned between the pair of active valves 24, whereby an upstream active valve or first active valve 24 is adjacent to the compressor 12 and a downstream active valve or second active valve 24 is adjacent to the combustion chamber 17 and the burner 18. In practice, the reservoir 26 stores the volume of compressed air V2 prior to its entry into the combustion chamber 17 and the burner 18, which may enhance controllability of the compressor 12, the combustion chamber 17 and the burner 18 by way of providing a degree of separation between the operation of the compressor 12 and the operation of the burner 18. For instance, when a pressure level at the aft end 16 of the compressor 12 reaches a predetermined high level, the first active valve 24 adjacent to the aft end 16 opens to permit the volume of compressed air V2 to enter the reservoir 26, whereby the reservoir 26 has a pressure level that is lower than the predetermined pressure level of the compressor 12. The stored volume of compressed air V2 can subsequently be fed into the combustion chamber 17 and the first end 20 of the burner 18 when the second active valve 24 is opened, which may occur at a certain temperature setting and/or a pressure level setting of the reservoir 26, the combustion chamber 17 and/or the burner 18, as stipulated by the control system 25. In this way, the first active valve 24 may be controlled depending on various characteristics of the compressor 12, while the second active valve 24 is controlled depending on various characteristics of the combustion chamber 17 and/or the burner 18.

Referring yet again to FIGS. 1 and 2, it is contemplated that the compressor 12 includes one or more one-way valves 28 located at the forward end 14 of the compressor 12. In one embodiment, the one-way valve 28 is a passive valve. The one-way valve 28 controls the intake of the first volume of air V1 into the compressor 12 by permitting entry of ambient air or the first volume of air V1 from outside of the compressor 12 when a vacuum is created as the volume of compressed air V2 leaves the compressor 12. The one-way valve 28 also prevents air within the compressor 12 from leaking out of the forward end 14 of the compressor 12. In a particular embodiment, the one-way valve 28 is a reed valve.

Still referring to FIGS. 1 and 2, it is contemplated that the compressor 12 is shaped to sustain the standing wave W during operation while air flows in and out of a compression chamber 30 defined in the compressor 12. In particular, it is contemplated that at least one of the forward end 14 and the aft end 16 of the compressor 12 has a tapered geometry, as shown in FIGS. 1 and 2. In other embodiments, only the aft end 16 of the compressor is tapered and smaller than the forward end 14 of the compressor 12. In alternative embodiments, any suitable geometry may be contemplated for the compressor 12 that provides for a maximum level of compression and a required amount of air flow through the pulsejet engine 10.

As schematically shown in FIG. 2, in an alternative embodiment, the compressor 12 is movably mounted to a body 29 to allow the compressor 12 to move in a forward-aft motion relative to the body 29. The forward-aft motion, which, in one embodiment, is driven by a pulsed nature of the exhaust gas exiting a tailpipe 31 of the pulsejet engine 10, causes standing waves to form inside the compression chamber 30. A mounting frame 32 connecting the pulsejet engine 10 to the body 29 may be flexible and/or configured to sustain an operating frequency of the pulsejet engine 10 to permit such forward-aft movement of the compressor 12.

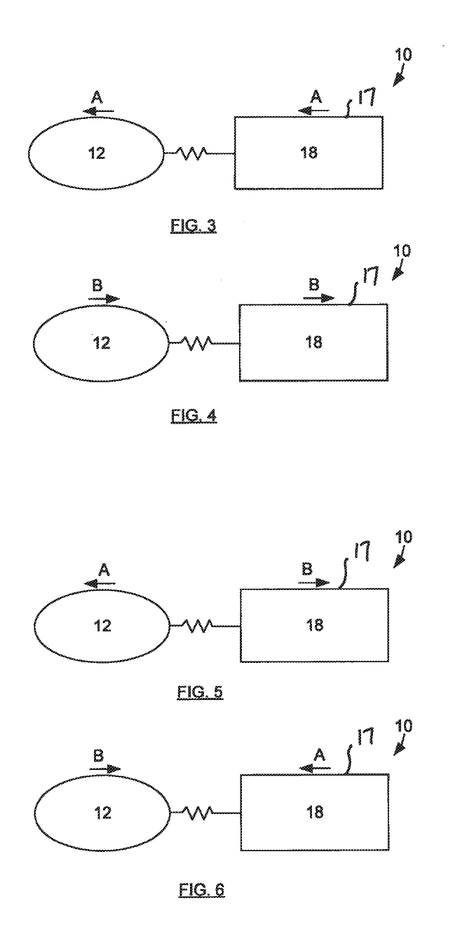

Turning now to FIGS. 3-6, the compressor 12 and the combustion chamber 17 may both operate at a same or different operating frequency, thereby causing the compressor 12 and the combustion chamber 17 to move in the same or opposing directions. For instance, FIGS. 3 and 4 illustrate a first mode of operation in which the compressor 12 and the combustion chamber 17 move in-phase. When the compressor 12 moves in a direction A, the combustion chamber 17 moves in the same direction A. When the compressor 12 moves in a direction B opposite direction A, the combustion chamber 17 also moves in the direction B. FIGS. 5 and 6 illustrate an alternative, second mode of operation whereby the compressor 12 and the combustion chamber 17 move in opposite directions, also referred to as out-of-phase. For instance, as the compressor 12 moves in the direction A, the combustion chamber 17 moves in the opposite direction B. The compressor 12 and the combustion chamber 17 simultaneously move toward one another or simultaneously move away from one another, similar to the behavior of commonly known spring/mass/dampener systems. It is contemplated that the second mode of operation may be beneficial in reducing motion and vibrational effects of the pulsejet engine 10 on the body 29, such as an airframe. In one embodiment, the pulsejet engine 10 is configured to have an operational frequency that generates the standing wave W inside the compressor 12.

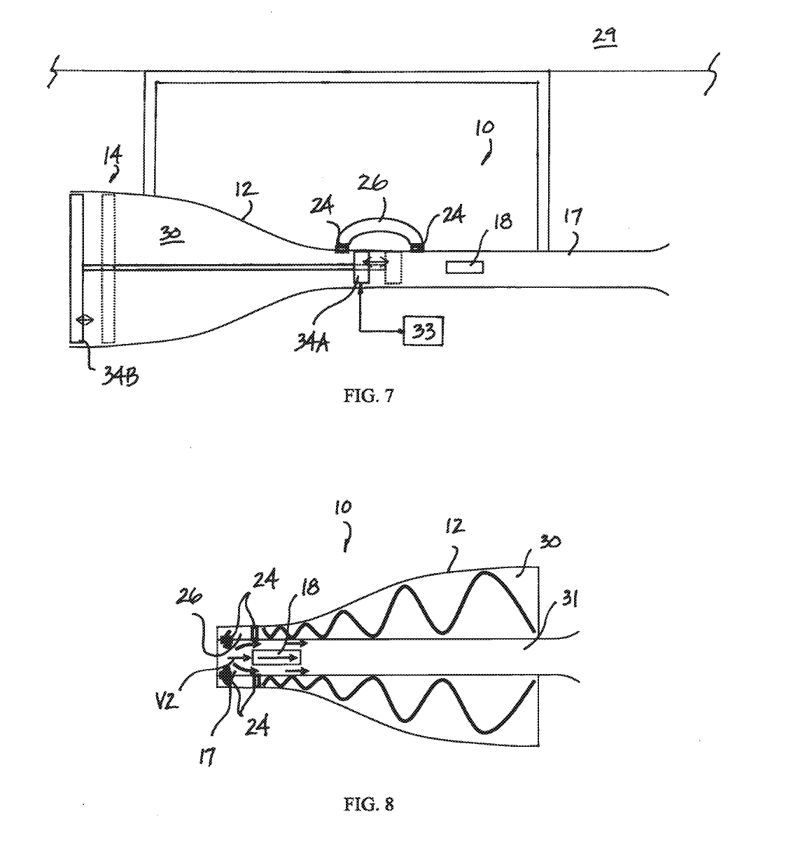

In another embodiment as shown in FIG. 7, the compressor 12 is mounted to the body 29 and stationary relative to the body 29. In this embodiment, the compressor 12 includes an external driver 33 that is adapted to generate the standing wave W inside the compressor 12. As shown in FIG. 7, the external driver 33 is operatively coupled to a piston or a diaphragm 34A moveably positioned within the combustion chamber 17 and operatively coupled to a piston or a diaphragm 34B moveably positioned within the compressor 12, for example at the forward end 14 of the compressor 12. In a particular embodiment, the diaphragm 34B is driven by the pressure pulses from the combustion chamber 17 to set up the standing wave within the compressor 12. In this embodiment, the compressor 12 uses only the diaphragm 34B to move the air as the combustion chamber 17 and the outer walls of the compressor 12 are stationary. The external driver may also be controlled by the control system 25 described above in conjunction with the active valve 24.

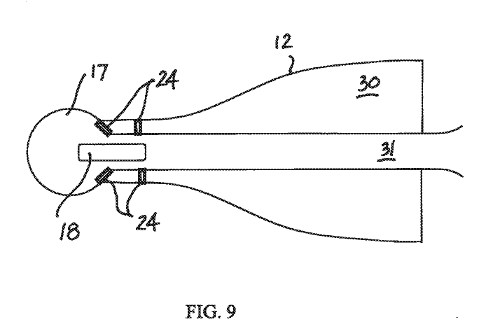

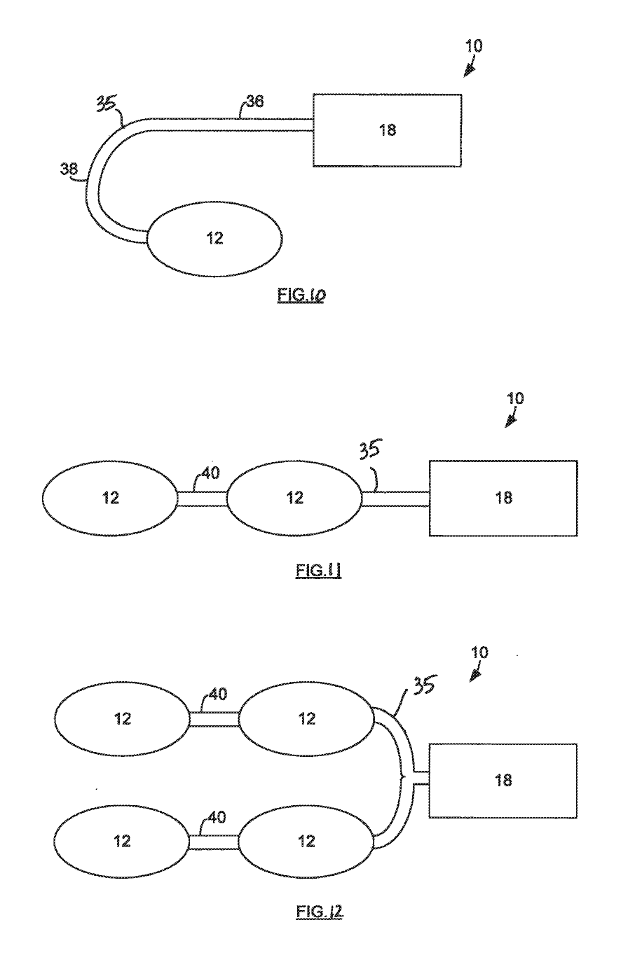

As shown in FIGS. 8 and 9, in an alternative embodiment of the pulsejet engine 10, the tail pipe 31 runs through at least a portion of the compressor 12, for example, through a middle portion of the compressor 12. The compressor 12 is adapted to intake the first volume of air V1 and to release the volume of compressed air V2. In one embodiment, the forward end 14 is adapted to intake the first volume of air V1 and the aft end 16 is adapted to release the volume of compressed air V2. In alternative embodiments, the first volume of air V1 may enter at or near the forward end 14, at or near the aft end 16 and/or at one or more locations between and including the forward end 14 and the aft end 16. The one or more locations through which air enters the compressor 12, for example, through the passive valves 28, depends, at least in part, on the design and configuration of the compressor 12.

As shown in FIGS. 8 and 9, the reservoir 26 is positioned between the pair of active valves 24, whereby an upstream active valve or first active valve 24 is adjacent to the compressor 12 and a downstream active valve or second active valve 24 is adjacent to the combustion chamber 17 containing the burner 18. In practice, the reservoir 26 stores the volume of compressed air V2 prior to its entry into the combustion chamber 17. The stored volume of compressed air V2 can subsequently be fed into the burner 18 positioned within the combustion chamber 17 when the second active valve 24 is opened, which may occur at a certain temperature setting and/or a pressure level setting of the reservoir 26 and/or the burner 18, as stipulated by the control system 25. Referring further to FIG. 9, part or all of the combustion chamber 17 may be outside the compressor 12, as well as the end of the tailpipe 31. Further, the tailpipe 31 may form an inner wall of the compressor 12 or be formed of a separate pipe.

Referring now to FIG. 10, in one embodiment a connection 35 is positioned between the aft end 16 of the compressor 12 and the combustion chamber 17. The connection 35 provides for fluid communication of airflow between the compressor 12 and the combustion chamber 17. The connection 35 may be straight, bent or curved, or may include one or more straight sections and/or one or more bent or curved sections. Merely by way of example, FIG. 10 illustrates one embodiment of the connection 35 that includes a straight portion 36 and a curved or bent portion 38. At least a portion of the active valve 24 and/or the reservoir 26 is provided on the connection 35. In one embodiment, the connection 35 is formed from an elastic material, such as a suitable rubber or silicon material. In a particular embodiment, the connection 35 is a tube configured to have a stiffness that permits an in-phase mode of operation and/or an out-of-phase mode of operation of the pulsejet engine 10, as described above.

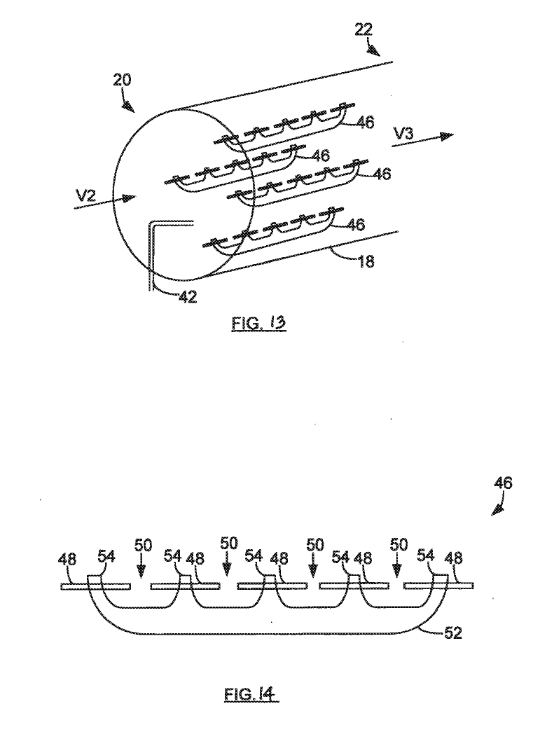

Turning to FIGS. 11 and 12, various arrangements for a compressor assembly are shown. FIG. 11 illustrates a plurality of compressors 12 provided in series. It is contemplated that a plurality of compressors 12 provided in series increases a total pressure of compressed air flowing to the combustion chamber 17. FIG. 12 illustrates two series of compressors 12 that are provided in parallel to one another. In this embodiment, the parallel arrangement of the compressors 12 yields an increased mass flow to the combustion chamber 17. At least one or more of the compressors 12 provided in the series arrangement and the parallel arrangement is a standing wave compressor. In certain embodiments, the compressor assembly includes a combination of compressors 12 in series and compressors 12 in parallel to one another. Further, it is contemplated that a coupling component 40 is operatively engaged between each adjacent compressor 12 to allow for fluid communication of airflow. In certain embodiments, the coupling component 40 is flexible and/or stiff depending on the desired movement of the linked compressors 12 relative to one another. For instance, the compressors 12 in series or in parallel may be adapted to move in-phase, out-of-phase, or a combination of both. Further, it is contemplated that any number of compressors 12 may be provided in series or in parallel to achieve various performance requirements of the pulsejet engine 10.

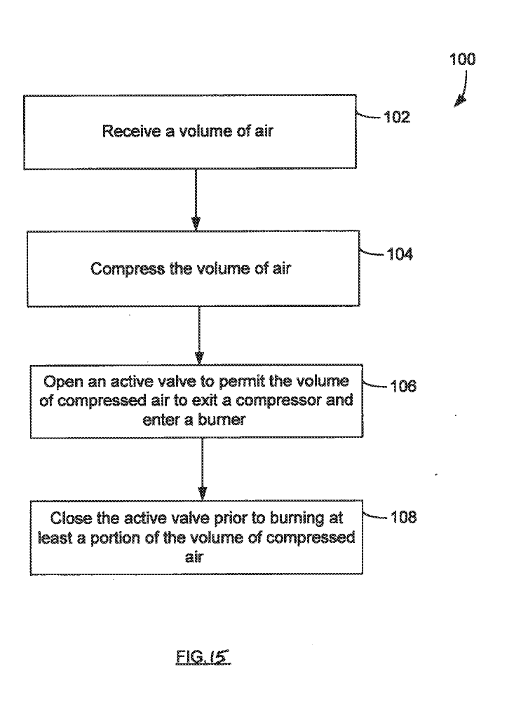

Turning now to FIG. 13, a portion of the burner 18 is shown. The burner 18 is configured to mix the volume of compressed air V2 leaving the compressor 12 with fuel for burning. The fuel may be provided by one or more fuel injectors 42 disposed on a portion of the burner 18 positioned within the combustion chamber 17. In some embodiments, all of the volume of compressed air V2 in the combustion chamber 17 is burned in the burner 18. In another embodiment, a portion of the volume of compressed air V2 in the combustion chamber 17 is burned in the burner 18, which may provide for increased fuel efficiency. Further, as shown in FIGS. 13 and 14, it is contemplated that the burner 18 includes one or more ignition points 46 defined by multiple rods 48 separated by multiple gaps 50 that permit sparks to jump therebetween and increase a rate of combustion. In particular, a base 52 having a plurality of teeth 54 may extend axially across a longitudinal length of the burner 18, with each of the plurality of teeth 54 supporting each of the plurality of rods 48. As shown in FIG. 14, five rods 48 are disposed on the base 52 having five teeth 54 and thereby defining four gaps 50; however, any number of rods 48, gaps 50, and teeth 54 may be provided. In operation, each ignition point 46 can be initiated with an ignition timing process in the burner 18. The ignition timing process may be controlled, at least in part, by the control system 25 described above. It is contemplated that the ignition timing process includes staggering ignition from the first end 20 of the burner 18 to the second end 22 of the burner 18. Such timing processes may increase performance of the pulsejet engine 10.

It is contemplated that the pulsejet engine 10 described herein may be operated according to various methods. Merely by way of example, referring to FIG. 15 one method of operation 100 for a pulsejet engine includes receiving 102 a volume of air V1 within the compressor 12 and compressing 104 the volume of air V1 toward the aft end 16 of the compressor 12, whereby compression of the volume of air V1 is provided for by standing waves W that are formed inside the compressor 12. In a particular embodiment, the volume of air V1 is received at or near the forward end 14 of the compressor 12. In this embodiment, the active valve 24 that is operatively coupled to the aft end 16 of the compressor 12 is opened 106 to permit the volume of compressed air V2 to exit the compressor 12 and enter the burner 18 positioned within the combustion chamber 17 in fluid communication with the compressor 12. The active valve 24 is closed 108 prior to burning at least a portion of the volume of compressed air V2 in the burner 18.

In one embodiment, a compressor assembly for the pulsejet engine 10 includes the compressor 12 coupled in fluid communication to the combustion chamber 17 and the first end 20 of the burner 18 positioned within the combustion chamber 17. The compressor 12 is adapted to intake the first volume of air V1 and to release the volume of compressed air V2. The burner 18 is configured to receive the volume of compressed air V2 and release the volume of burned compressed air and fuel mixture V3, which proceeds downwardly through the tailpipe 31. Further, the compressor assembly includes the active valve 24 that is operatively coupled between the compressor 12 and the combustion chamber 17 and the burner 18. The active valve 24 is adapted to control entry of the volume of compressed air V2 into the combustion chamber 17. The standing wave W is formed inside the compressor 12 and utilized for compressing the first volume of air V1 during operation of the pulsejet engine 10.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Additionally, the features of various implementing embodiments may be combined to form further embodiments.

1. A pulsejet engine, comprising:
a compressor adapted to intake a first volume of air and to release a volume of compressed air;
a combustion chamber in fluid communication with the compressor;
a burner positioned in the combustion chamber, the burner including a first end configured to receive the volume of compressed air and a second end configured to release a volume of a burned compressed air and fuel mixture; and
an active valve operatively coupled between the compressor and the combustion chamber, the active valve adapted to control entry of the volume of compressed air into a first end of the burner,
wherein a standing wave is formed inside the compressor to compress the first volume of air during operation of the pulsejet engine.

2. The pulsejet engine of claim 1, wherein the pulsejet engine is configured to have an operational frequency that generates the standing wave inside the compressor.

3. The pulsejet engine of claim 1, wherein the burner comprises a plurality of ignition points having multiple rods separated by multiple gaps that permit sparks to jump therebetween and increase a rate of combustion.

4. The pulsejet engine of claim 1, wherein an ignition timing process in the burner is staggered from the first end to the second end of the burner to increase performance.

5. The pulsejet engine of claim 1, wherein the active valve allows a frequency of the pulsejet engine to be controlled such that when at least one of a combustion chamber pressure and a burner pressure is below a compressor pressure, the active valve is opened.

6. The pulsejet engine of claim 1, wherein the active valve is closed prior to a combustion process in the burner.

7. The pulsejet engine of claim 1, further comprising a first active valve and a second active valve separated by a reservoir disposed therebetween, wherein the first active valve is adjacent to the compressor and the second active valve is adjacent to the combustion chamber.

8. The pulsejet engine of claim 7, wherein when a pressure level at an aft end of the compressor reaches a predetermined high level, the first active valve opens to permit the volume of compressed air to enter the reservoir, wherein the reservoir has a pressure that is lower than the predetermined high level.

9. A method of operation for a pulsejet engine, the method comprising:
receiving a volume of air within a compressor;
compressing the volume of air toward an aft end of the compressor, wherein compression of the volume of air is provided for by standing waves formed inside the compressor;
opening an active valve operatively coupled to the aft end of the compressor to permit a volume of compressed air to exit the compressor and enter a burner positioned within a combustion chamber in fluid communication with the compressor; and
closing the active valve prior to burning at least a portion of the volume of compressed air in the burner.

10. The method of claim 9, further comprising moving the compressor and the combustion chamber in-phase in a first mode of operation.

11. The method of claim 9, further comprising moving the compressor and the combustion chamber out-of-phase in a second mode of operation.

12. The method of claim 9, further comprising providing a connection positioned between the compressor and the combustion chamber, wherein the connection is one of straight and curved.

13. The method of claim 12, wherein the connection comprises an elastic material.

14. The method of claim 12, wherein the connection is a tube having a stiffness that permits an in-phase or out-of-phase mode of operation of the pulsejet engine.

15. A compressor assembly for a pulsejet engine, the pulsejet engine including a burner positioned within a combustion chamber of the pulsejet engine, the compressor assembly comprising:
a compressor coupled in fluid communication with the combustion chamber, the compressor adapted to intake a first volume of air and to release a volume of compressed air, wherein the combustion chamber and the burner are configured to receive the volume of compressed air and release a volume of a burned compressed air and fuel mixture; and
an active valve operatively coupled between the compressor and the combustion chamber, the active valve adapted to control entry of the volume of compressed air into a first end of the combustion chamber, wherein a standing wave is formed inside the compressor to compress the first volume of air during operation of the pulsejet engine.

16. The compressor assembly of claim 15, wherein at least one of a forward end and an aft end of the compressor has a tapered geometry.

17. The compressor assembly of claim 15, wherein an aft end of the compressor is tapered and smaller than a forward end of the compressor.

18. The compressor assembly of claim 15, wherein the compressor is shaped to provide for a maximum level of compression and a required amount of air flow through the pulsejet engine.

19. The compressor assembly of claim 15, wherein more than one compressor is provided in a parallel arrangement to increase a mass flow to the burner.

20. The compressor assembly of claim 15, wherein more than one compressor is provided in a series arrangement to increase a total pressure of flow to the burner.
